(19) United States
(12) Patent Application Publication
(10) Pub. No.: US 2001/0025930 A1
(43) Pub. Date: Oct. 4, 2001

(54) Method for the detection and analysis of a specimen

(75) Inventors: Johann Engelhardt, Bad Schoenborn (DE); Werner Knebel, Kronau (DE)

Correspondence Address: Simpson, Simpson & Snyder, L.L.P., 5555 Main Street, Williamsville, NY, 14221, US

(73) Assignee: Leica Microsystems Heidelberg GmbH, Mannheim (DE)

(21) Appl. No.: 09/817,915

(22) Filed: Mar. 26, 2001

(30) Foreign Application Priority Data
Mar. 28, 2000 (DE) 100 15 121.3

(51) Int. Cl. G01N 21/64

(52) U.S. Cl. 250/459.1

(57) ABSTRACT

The present invention concerns a method for the detection and analysis of a specimen in confocal fluorescent scanning microscopy (1), the specimen being detected at a definable system parameter setting (2), and for an optimum system parameter setting (2) and for optimum setting of the detection wavelength regions (21, 22) in consideration of the specimen being detected, is characterized in that the detected specimen data (3) are processed according to a definable algorithm (4); and that for further data detection, the system parameter setting (2) is improved on the basis of the processed specimen data (3).

### CROSS REFERENCE TO RELATED APPLICATIONS

This invention claims priority of a German patent application DE 100 15 121.3 filed Mar. 28, 2000 which is incorporated by reference herein.

### FIELD OF THE INVENTION

The present invention concerns a method for the detection and analysis of a specimen in confocal fluorescent scanning microscopy, the specimen being detected at a definable system parameter setting.

### BACKGROUND OF THE INVENTION

Confocal fluorescent scanning microscopes have been known from practical use for years, and are utilized in particular for medical and biological applications. In particular, DE 199 02 625 discloses a confocal fluorescent scanning microscope that has a detector module with which several detection wavelength regions can be variably set. The essential advantage of this scanning microscope as compared to confocal scanning microscopes having a permanently defined filter set is that it is very flexible in use so that almost all fluorescent dyes are detectable with this detector module, without being confined to the permanently installed filter sets of the conventional filter detector modules (and thus to predefined fluorescent dyes).

Confocal scanning microscopes demand that the user have sufficient knowledge about the operation of such a scanning microscope, specifically in order to set the interdependent and often also mutually counteracting system parameters. These include the pinhole diameter, amplifier voltage and amplifier offset of the photomultiplier, laser output, etc. As further system parameters for the detector module known from DE 199 02 625, it is necessary to set the detection wavelength regions; here in particular, a great deal of variation and combination is possible, since the user must define or specify the initial wavelength and final wavelength for each detection wavelength region. If a user does not optimally set the system parameters of the scanning microscope, the result is an image with reduced image quality, making the desired analysis of the recorded image data difficult or, in some circumstances, impossible.

DE 198 53 407 discloses, per se, a method for setting the system parameters of a scanning microscope. Here the user defines, by way of an interactive user interface, at least one specimen parameter and/or at least one selectable system parameter setting. The other system parameters are suggested to the user and/or set automatically.

The method known from DE 198 53 407 is helpful for an initial data recording, especially for inexperienced users of a scanning microscope. Additional assistance in setting the system parameters, especially as a function of the specimen to be detected, is not provided in this method.

### SUMMARY OF THE INVENTION

It is therefore the object of the present invention to establish the system parameter setting and the setting of detection wavelength regions in the context of confocal fluorescent scanning microscopes optimally in consideration of the specimen to be detected.

The method according to the present invention is achieved by a method for analysis of a specimen in confocal fluorescent scanning microscopy (1) comprising the steps of:

a. detecting of specimen data (3) from light coming from the specimen at a definable system parameter setting (2),

b. processing said specimen data (3) according to a definable algorithm (4)

c. improving the system parameter setting (2)on the basis of the processed specimen data (3) for a further data detection.

What has been recognized according to the present invention is firstly that the setting for the system parameters can be optimized by first performing a specimen detection with the confocal fluorescent scanning microscope at a definable system parameter setting. The definable system parameter setting could, for example, be made using the method known from DE 198 53 407. The initially detected specimen data are then processed with an algorithm that extracts qualitative and/or quantitative information from the specimen data set. With the aid of that information, either a new data recording is then automatically performed with an improved system parameter setting, or alternative possibilities for further data detection are indicated to the user.

The procedure according to the present invention makes possible a systematic and progressive improvement in the system parameter setting with or without the participation of the user of the confocal scanning microscope. Repeated execution of the method according to the present invention results, ideally, in an optimization of the system parameter setting of the confocal fluorescent scanning microscope, i.e. ultimately in an optimization of the detected specimen data quality. In particularly advantageous fashion, the user of a scanning microscope is no longer forced to modify all the relevant system parameters with a “trial and error” method, performing a data recording each time until finally the recorded specimen data permit reasonable specimen data analysis in terms of quality.

The most important system parameters relevant for the method according to the present invention are:

excitation wavelength;

output of the light source;

detection wavelength region;

amplifier voltage and amplifier offset of the photomultiplier or detector system;

diameter of the excitation and detection pinholes;

number of averagings of repeatedly scanned specimen regions;

scanning speed;

scanning density of the illumination pattern;

scanned lateral or axial image field size;

magnification factor.

The detected specimen data usually contain intensity data for the specimen as a function of the local coordinates. For multiple-color fluorescent applications in particular, the detected specimen data can contain wavelength information—present, for example, in the form of a spectrum—for each local coordinate. From these data, far-reaching conclusions as to specimen properties can be drawn on the basis of color shifts or changes in a dye, or the displacement of emission profiles. When living specimens are being examined, for example to answer physiological questions, the detected specimen data may contain time information. In this context, the change over time in a fluorescent dye concentration could exist as a function of the local coordinate of the specimen. In addition, the detected specimen data could contain polarization information and/or fluorescence lifetime information.

The algorithm according to which the detected specimen data are processed could comprise a comparison of several detected specimen data sets. In this context, preferably the same classes of information are compared to one another, for example the wavelength information for the first detected specimen data set with those of the second. A comparison among several specimen data classes from several detected specimen data sets, or a comparison of different specimen data classes of several detected specimen data sets, is also conceivable.

The algorithm could comprise the relationship among several detected specimen data sets. Preferably only two detected specimen data sets are to be correlated with one another. It is also conceivable to correlate one specimen data set with several other specimen data sets; for example, a first specimen data set could be correlated with the subsequently recorded specimen data sets in a time-series recording.

In a concrete embodiment, the algorithm comprises a determination of the signal-to-noise ratio of the detected specimen data. The value resulting from this determination is a quantitative indicator of the quality of the detected specimen data, and could be utilized in particular to optimize the specimen data quality.

In a preferred embodiment, the algorithm comprises creation of a histogram of the detected specimen data. The histogram can refer, in this context, to one individual specimen data class; a histogram of several or all specimen data classes of a specimen data set is also conceivable.

In a preferred embodiment, provision is made for a convolution and/or correlation operation on the detected specimen data. In this context, the convolution could be performed between several detected specimen data sets, or between a detected specimen data set and a model data set. The convolution of detected specimen data sets with a mask function is also conceivable. An autocorrelation of a detected specimen data set with itself, or a cross-correlation of two detected specimen data sets with one another, could be provided as the correlation operation. The convolution can be accomplished in either the local space or the frequency space. Corresponding transformations from the local space into the frequency space would then need to be incorporated into the algorithm and correspondingly applied.

The algorithm could comprise a pattern recognition operation and/or a structural analysis of the detected specimen data. The algorithm could also extract specimen shape parameters. Ultimately the detected specimen data could be examined with the aid of the algorithm to determine whether a predefined specimen pattern or a predefined specimen structure and/or number of specimens is present, and the degree to which the measured specimen properties conform to the definition. The pattern recognition and/or structural analysis could, in this context, be performed with current methods of digital image processing.

The algorithm could comprise a sorting and/or segmentation and/or filtration of the detected specimen data. The corresponding operation could act on the local space, on the Fourier space, on the color space, or on the time space. The algorithm could be applied in the same fashion to the detected specimen polarization information or to the detected specimen lifetime information.

In particularly advantageous fashion, the algorithm takes into account the system parameter settings of the previous data detection. The system parameter setting of the detection wavelength regions is very important especially in analysis of the wavelength information of the detected specimen data, and is therefore incorporated into the algorithm.

The algorithm is coupled to an expert system. The expert system could, for example, comprise a database in which previous recordings of specimen data sets, along with their classification or improved system parameter setting, are stored.

In addition, the algorithm could contain fuzzy-logic methods. Fuzzy-logic methods could be utilized in particular in the analysis of wavelength information of the detected specimen data sets, or in the definition of subjective analysis features.

A combination of the various aforementioned algorithms for processing of the detected specimen data is also provided for. In particular, the algorithms could be of modular configuration, thus allowing complex data processing to be achieved by assembling several modules.

In a particularly preferred embodiment, the algorithm comprises a graphic processing of the detected specimen data. This graphic processing is accomplished in a one-dimensional and/or multidimensional data representation. In very general terms, all specimen data detected from the specimen are provided for the data representation. In the interest of a clearly organized data representation, the graphic processing can be limited to the representation of a single specimen datum. The specimen data can contain intensity information, color information, wavelength information, time information, polarization information, and/or fluorescence lifetime information.

For multidimensional data representation, the graphic processing could be accomplished in the form of a height plot. This height plot representation could be based on a line and/or an image plane and/or an image region of the detected specimen data. For example, the height plot representation of an image plane would show its coordinate system in a pseudo-3D depiction; for each XY value of the image plane, the corresponding information value—for example the fluorescence lifetime or fluorescence intensity—is plotted in the Z direction. Alternatively, the graphic processing is performed in the form of a histogram. For example, the quantitative frequency with which various intensity values occur could be plotted as a function of the intensity values. The specimen information class to be represented may make it necessary to configure the histogram representation in multidimensional fashion. This is necessary especially if the specimen information class to be represented contains multidimensional information entries, for example a complete wavelength spectrum for each individual specimen point of the specimen data set.

In addition, an extreme value representation or a representation of characteristic values of the detected specimen data is provided for the graphic processing. For the extreme value representation of wavelength information of detected specimen data, for example, each XYZ point of the measured specimen data set could be depicted in the color which corresponds to the wavelength at which the spectrum of that point exhibits a maximum. The representation of characteristic values of the detected specimen data could, for example, be an emphasis of all those specimen points that are marked with two different fluorescent dyes. Very generally, the representation can refer to all existing specimen information classes.

The graphic processing is output by an output apparatus. The output apparatus could be a monitor of a computer, a stereo display, or an output apparatus suitable for virtual reality. In a preferred embodiment, the graphic output is accomplished during data recording.

Once the detected specimen data have been processed with the definable algorithm, a further data recording is performed, preferably automatically, on the basis of definable objective and/or subjective criteria. In this context, the definable criteria are compared to the resulting values of the algorithm. If the comparison reveals that the criterion for further data recording is met, then a further data detection is performed with an improved system parameter setting. A criterion for a further data recording in this context could be optimization of the signal yield or optimization of the specimen separation.

Alternatively, provision could be made for a selection of different detection possibilities to be automatically suggested to the user for the further data recording. Each suggestion could depict a different possibility for optimizing further data detection, so that ultimately a specimen data recording is made in such a way as to make possible the data analysis desired by the user.

### BRIEF DESCRIPTION OF THE DRAWINGS

There are various ways of advantageously embodying and developing the teaching of the present invention. Reference is made to the drawings. In the drawings:

FIG. 1 schematically depicts the method according to the present invention;

FIG. 2 schematically depicts a confocal fluorescent scanning microscope in the context of which the method according to the present invention is implemented;

FIG. 3 shows a diagram of the wavelength information of measured specimen data;

FIG. 4 shows a schematic representation of the wavelength information of a specimen point;

FIG. 5 shows a height plot representation of a specific wavelength datum of a specimen point;

FIG. 6 shows a further information representation of a specimen point; and

FIG. 7 schematically shows a multidimensional histogram representation.

### DETAILED DESCRIPTION OF THE INVENTION

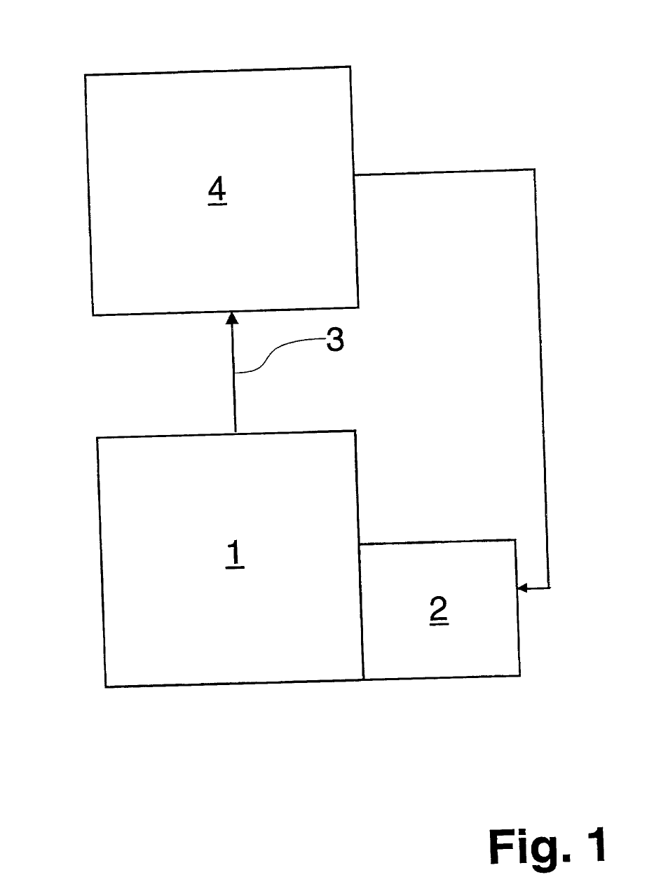

FIG. 1 shows a schematic depiction of a method for the detection and analysis of a specimen with a fluorescent scanning microscope 1, the specimen being detected at a definable system parameter setting 2.

According to the present invention, the detected specimen data 3 are processed according to a predefinable algorithm 4. For further data detection, the system parameter setting 2 is improved on the basis of the processed specimen data.

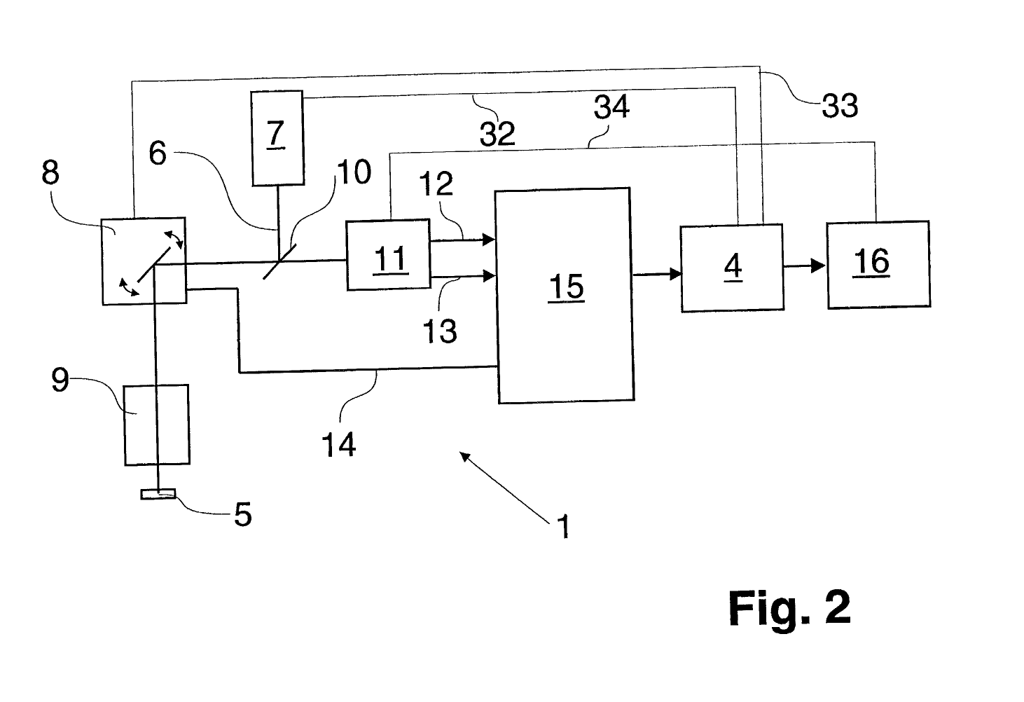

FIG. 2 shows, in a schematic depiction, the individual assemblies of a confocal fluorescent scanning microscope 1 with which a specimen, marked with two fluorescent dyes, is detected in order thereby to obtain wavelength information for the specimen. For that purpose, specimen 5 is illuminated with exciting light 6 of laser light source 7. Scanning apparatus 8 deflects the illuminating beam in the X-Y direction so that a two-dimensional image of the specimen can be recorded. Exciting light 6 is focused by objective 9 to a point. The fluorescent light produced by exciting light 6 passes through objective 9 and scanning apparatus 8, and through dichroic beam splitter 10. The fluorescent light detected by detector module 11 supplies intensity signals 12, 13 of the two fluorescent dyes with which specimen 5 is specifically marked. Together with position signal 14 of scanning apparatus 8, control module 15 of confocal fluorescent scanning microscope 1 arranged downstream from detector module 11 generates a specimen image. Control module 15 stores the initially recorded specimen data as a function of position signal 14, so that one image plane is present for each recorded specimen plane of each fluorescent dye. The detected specimen data are further processed by the defined algorithm 4, which comprises segmentation of the specimen data in the color space. The segmented specimen data are made available to the user on output apparatus 16 in the form of a graphic depiction.

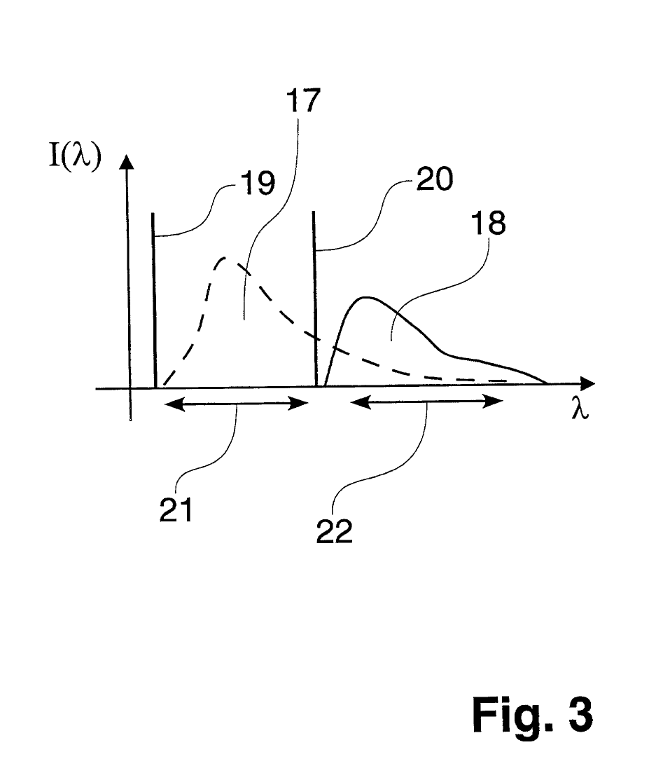

FIG. 3 shows a diagram in which emission spectra 17, 18 of the two fluorescent dyes are plotted. The diagram shows spectral intensity as a function of wavelength. Also shown are the two excitation wavelengths 19, 20 of laser light source 7. The number 21 indicates the detection wavelength region of detector module 11 for the one fluorescent dye, and 22 correspondingly shows the detection wavelength region of the second fluorescent dye. Excitation wavelengths 19, 20 and detection wavelength regions 21, 22 are, respectively, system parameters whose settings are to be optimized with the method according to the present invention.

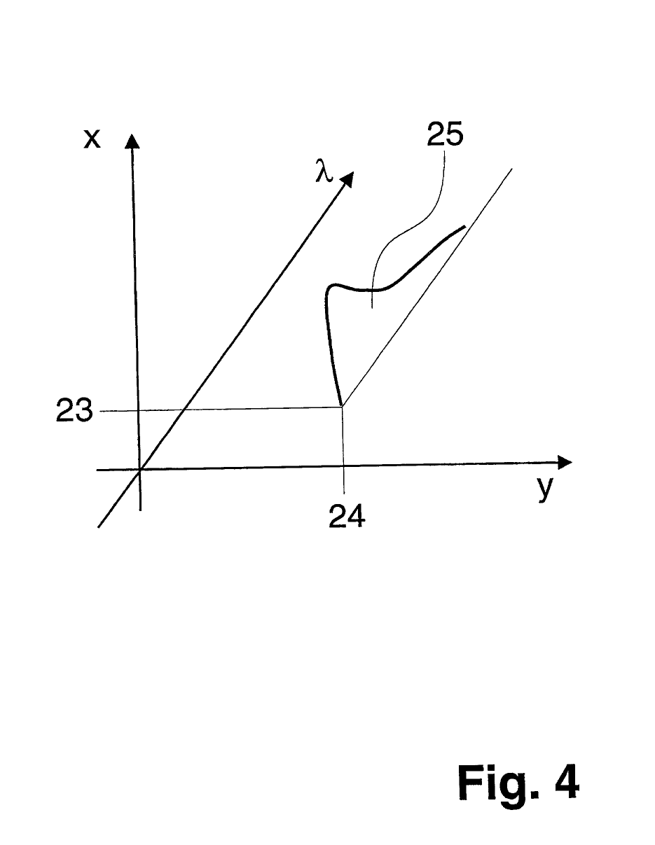

FIG. 4 schematically depicts the measured spectral intensity of a specimen point having coordinates 23, 24. The measured spectral curve 25 of wavelength datum λ of the specimen point having X-Y coordinates 23, 24 is shown in the third spatial direction.

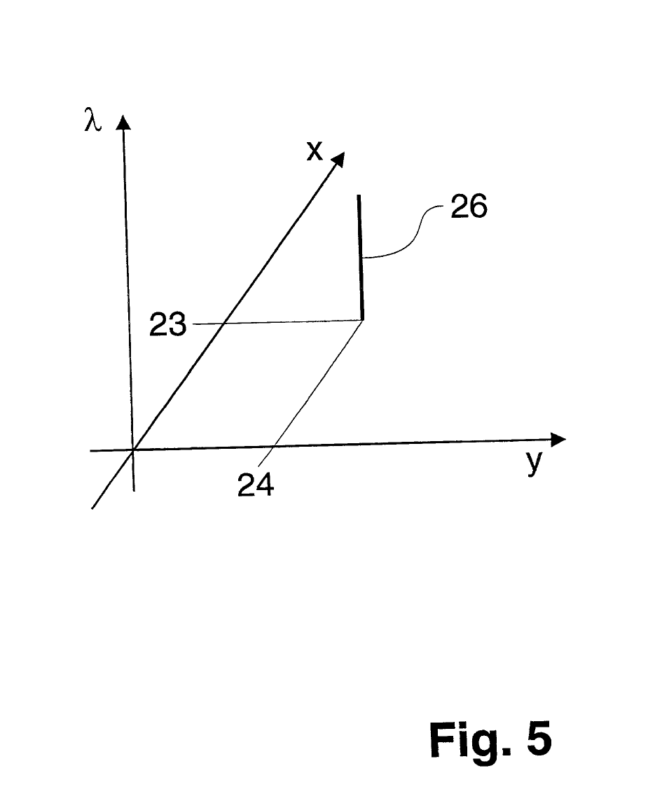

FIG. 5 shows a height plot representation 26 of the measured specimen points of the X-Y plane. The characteristic value of the maximum of measured spectrum 25 from FIG. 4 at this point 23, 24 is depicted by way of example.

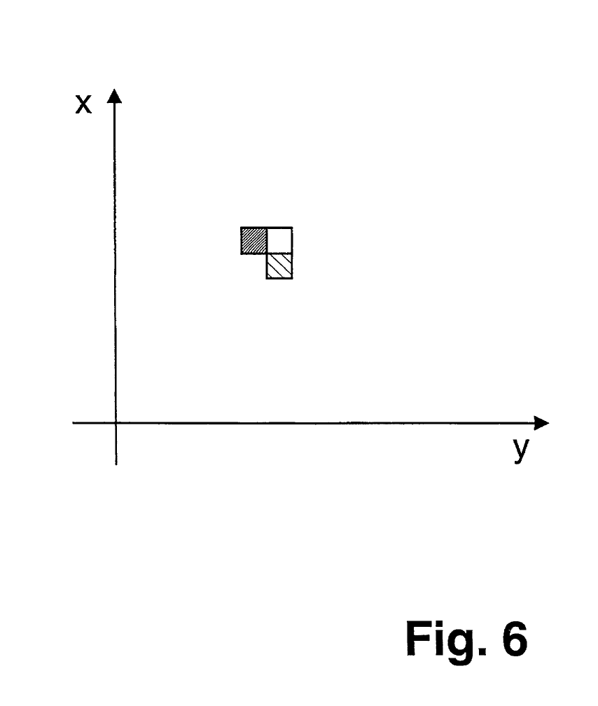

FIG. 6 schematically depicts a two-dimensional fluorescence lifetime representation of three plotted specimen points of an X-Y plane. Intensity values shown in white represent a short fluorescence lifetime; brightness values of decreasing intensity represent longer fluorescence lifetimes.

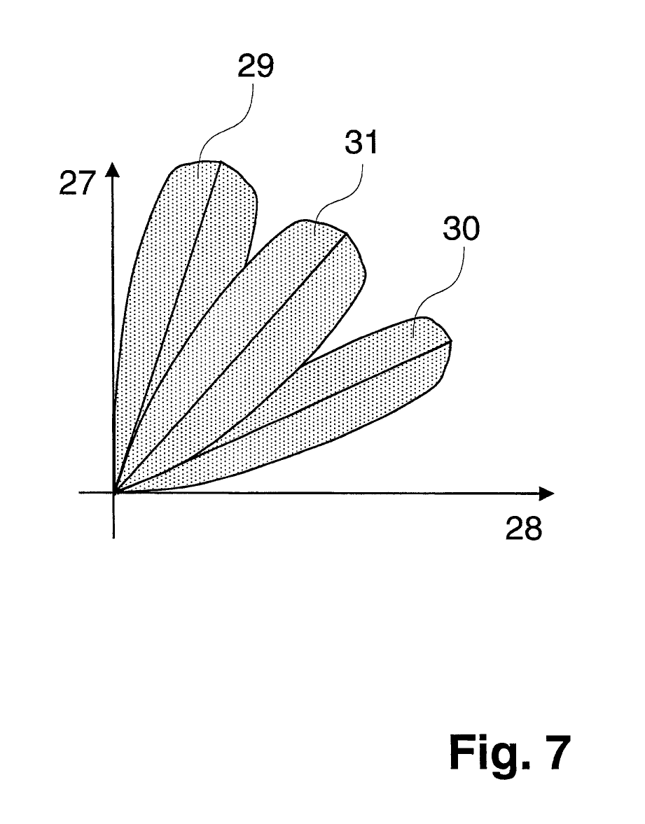

FIG. 7 shows a two-dimensional histogram representation. The frequencies of occurrence of the first fluorescent dye are plotted along direction 27, and the frequencies of the second fluorescent dye are plotted along direction 28. Measurement lobe 29 contains contributions from all those specimen points at which principally the first fluorescent dye was measured. The contribution made to measurement lobe 30 was mostly from specimen points at which principally the second dye is located. Specimen points at which both the one dye and the other dye are located are shown in measurement lobe 31.

For further data detection, provision is made in the context of predefinable algorithm 4 for the initially measured specimen data as shown in FIGS. 4 through 7 to be represented on output apparatus 16. FIG. 2 indicates in merely schematic fashion that prior to a further data recording, predefinable algorithm 4 sets or improves a system parameter relevant to laser light source 7 via connecting means 32, and a system parameter relevant to scanning apparatus 8 via connecting means 33. Concretely, after a first data recording the laser output of excitation wavelength 20 is increased, and the scanning speed of scanning apparatus 8 is reduced. It is also schematically indicated that by way of connecting means 34, output apparatus 16 modifies system parameters relevant to detector module 11. This change is accomplished, however, interactively with the user of confocal fluorescent scanning microscope 1, who decreases the width of the one detection wavelength region 21 of the one dye.

In conclusion, be it noted very particularly that the exemplary embodiments discussed above serve merely to describe the teaching claimed, but do not limit it to the exemplary embodiments.

### PARTS LIST

1 Confocal fluorescent scanning microscope

2 System parameter setting

3 Detected specimen data

4 Definable algorithm

5 Specimen

6 Exciting light

7 Laser light source

8 Scanning apparatus

9 Objective

10 Dichroic beam splitter

11 Detector module

12 Intensity signals of fluorescent dye A

13 Intensity signals of fluorescent dye B

14 Position signal

15 Control module

16 Output apparatus

17 Spectrum of fluorescent dye A

18 Spectrum of fluorescent dye B

19 First excitation wavelength (of 7)

20 Second excitation wavelength (of 7)

21 Detection wavelength region of fluorescent dye A

22 Detection wavelength region of fluorescent dye B

23 X coordinate of a specimen point

24 Y coordinate of a specimen point

25 Measured spectrum at point 23, 24

26 Height plot representation of point 23, 24

27 Frequencies of fluorescent dye A

28 Frequencies of fluorescent dye B

29 Frequency distribution of fluorescent dye A

30 Frequency distribution of fluorescent dye B

31 Frequency distribution of specimen points having fluorescent dye A and B

32 Connecting means between (4) and (7)

33 Connecting means between (4) and (8)

34 Connecting means between (16) and (11)

What is claimed is:

1. A method for analysis of a specimen in confocal fluorescent scanning microscopy (1) comprising the steps of:
a. detecting of specimen data (3) from light coming from the specimen at a definable system parameter setting (2),
b. processing said specimen data (3) according to a definable algorithm (4)
c. improving the system parameter setting (2)on the basis of the processed specimen data (3) for a further data detection.

2. The method as defined in claim 1, characterized in that the definable system parameter (2) is an excitation wavelength (19, 20), an output power of the light source (7), a detection wavelength region (21, 22), an amplifier voltage of a Photomultiplier, an amplifier offset of a Photomultiplier, an excitation pinhole diameter, a detection pinhole diameter, a number of averagings of repeatedly scanned specimen regions, a scanning speed, a scanning density of an illumination pattern, a scanned lateral or axial image field size or a magnification factor.

3. The method as defined in claim 1, characterized in that the specimen data (3) consists essentially of intensity information, wavelength information (17, 18, 25), time information, polarization information or fluorescence lifetime information.

4. The method as defined in claim 1, characterized in that specimen data sets are generated from a plurality of specimen data.

5. The method as defined in claim 4, characterized in that the algorithm (4) comprises a relationship of several specimen data sets to one another.

6. The method as defined in claim 1, characterized in that the algorithm (4) consists essentially of a determination of the signal-to-noise ratio of the specimen data (3), a creation of a histogram of the specimen data (3), a convolution or correlation operation on the specimen data (3) or a pattern recognition operation or a structural analysis of the specimen data (3).

7. The method as defined in claim 1, characterized in that the algorithm (4) comprises a graphic processing of the specimen data (3).

8. The method as defined in claim 7, characterized in that the graphic processing consists essentially of a at least one-dimensional intensity representation, a at least one-dimensional color representation, a at least one-dimensional wavelength representation, a at least one-dimensional polarization representation or a at least one-dimensional fluorescence lifetime representation.

9. The method as defined in claim 7, characterized in that the graphic processing is accomplished in the form of a height plot (26).

10. The method as defined in claim 9, characterized in that the height plot refers to a line or an image plane or an image region.

11. The method as defined in claim 7, characterized in that the graphic processing is performed in the form of a histogram.

12. The method as defined in claim 7, characterized in that the graphic processing comprises an extreme value representation.

13. The method as defined in claim 7, characterized in that the graphic processing comprises a representation of characteristic values of the specimen data (3).

14. The method as defined in claim 7, characterized in that the result of the graphic processing is transferred to an output apparatus (16), wherein a graphic output of the specimen data (3) is accomplished

15. The method as defined in claim 14, characterized in that the graphic output is accomplished during the detecting of specimen data.

16. The method as defined in claim 7, characterized in that a further detecting of specimen data is performed on the basis of definable objective or subjective criteria.

17. The method as defined in claim 16, characterized in that a criterion for the further detecting of specimen data is optimization of the signal yield.

18. The method as defined in claim 16, characterized in that a criterion for the further detecting of specimen data is optimization of the specimen separation.

19. The method as defined in claim 16, characterized in that a selection of different system parameter setting (2) possibilities is automatically suggested to the user for the further detecting of specimen data.
